(19) United States
(12) Patent Application Publication
(10) Pub. No.: US 2009/0281468 A1
(43) Pub. Date: Nov. 12, 2009

(54) Medication head-massaging healthcare and therapy apparatus

(76) Inventor: Jingfeng Xu, Beijing (CN)

Correspondence Address: ZHEN ZHENG LU, 1730 HUNTINGTON DRIVE #304, DUARTE, CA, 91010, US

(21) Appl. No.: 12/306,694

(22) PCT Filed: Mar. 14, 2007
(86) PCT No.: PCT/CN07/00818

§ 371 Date: Dec. 25, 2008

(30) Foreign Application Priority Data
Jun. 26, 2006 (CN) 200610090074.4

(51) Int. Cl. A61H 15/00; A61H 7/00

(52) U.S. Cl. 601/128; 601/134

(57) ABSTRACT

The present invention provides a medication head-massaging healthcare and therapy apparatus including a disposable medication cap and a helmet. The helmet includes an inner helmet and an outer helmet. At the same time, the inner helmet and the outer helmet are helmets which are connected to a top side, a left side and a right side so that a volume size of the helmet can be adjusted. The inner helmet is connected to a bottom chassis for a device mounting and a sound absorbing chassis, and a steel ball is mounted on the edges of the outer helmet. A flange is fixed to an axis of a subminiature driving electromotor rotation pin and a steel ball are connected each other in a groove at an eccentric position of the flange.

### BACKGROUND OF THE PRESENT INVENTION

1. Field of Invention

The present invention relates to a head-massaging healthcare and therapy apparatus, and more particularly to a head-massaging healthcare and therapy apparatus using medication. In detail, the present invention relates to a medical apparatus which performs a finger-pressure on every acupuncture point of a head at the same time with rubbing and massaging, so that medication can infiltrate into a head skin and ions can be absorbed. The medical apparatus has 36 massage rods, which equals to 36 fingers, performing a finger-pressure on every acupuncture point at the same time evenly and comfortably. Furthermore, an infrared rays unit is arranged in a neck area of a massage rod to adjust temperature so as to enhance the penetration of the medication to a head. A magnet plate is arranged in the outermost edge of the massage rod and the massage rod has functions to rotate and move forth and back repeatedly. A volume and size of the double-layer helmet can be adjusted simultaneously and the massage rods are automatically adjusted to the acupuncture points according to a size of a head. When a user sleeps during a massage, the medical apparatus is controlled by the timer via a remote controller.

2. Description of Related Arts

It is widely known that a healthcare and therapy can be realized by massaging an acupuncture point of a head of a human body. A head massage is conventionally performed by fingers of both hands. However, by using limited fingers, it is not possible perform a finger-pressure on many acupuncture points at the same time and a massage action can not performed evenly for a long time, because a person who performs a massage becomes very tired. Furthermore, by using fingers, medication can not be infiltrated through the acupuncture points as ions, and different shapes of massage rods have not been used to meet the different demands. A magnet device can not be used during a hand massage.

### SUMMARY OF THE PRESENT INVENTION

An object of the present invention is to provide a medication head-massaging healthcare and therapy apparatus, which comprises 36 massage rods of different shapes performing a massage to the acupuncture points on a head comfortably and evenly.

An infrared rays unit is arranged in the neck area of the massage rod to adjust temperature so as to enhance the medication penetration through an acupuncture point of a head. A magnet plate is arranged in the outermost edge of the massage rod and the massage rod has functions to rotate and move forth and back repeatedly. A volume and size of the double-layer helmet can be adjusted simultaneously according to a size of a head. When a user sleeps during a massage, the medical apparatus is switched by the timer via a remote controller.

The medication head-massaging healthcare and therapy apparatus comprises a case, a front panel and a bottom chassis for a helmet mechanism. Further, it further includes an electronic system, a wireless remote controller or a wired remote controller and etc.

The apparatus includes the double-layer helmet. In the helmet, 36 massage rods penetrate through an outer helmet and are inserted into corresponding holes. Each massage rod of an inner helmet is fixed to a guide of a bottom wall of a cylindrical shape which is corrugated and folded. Thus, 36 massage rods are arranged in the corresponding holes of the inner helmet. When the outer helmet rotates, it rotates or moves with centering around each massage rod and a hole where the guide is formed. A tip portion of an insertion massage rod rotates along a circumferential direction or rotates as an elliptic shape. A connection unit of the double-layer helmet is divided into three portions. A pair of round rods is arranged at an outer edge of a helmet and a pressure spring is arranged at an exterior side. The spring is formed by a stainless iron larger than a semicircle. A second subminiature driving electromotor 6 is fixed to a bottom side of the outer helmet for adjusting a size of the double helmet. In a bottom side of the case assembly, a head rest which is vertically extended to an inner side of a bottom chassis accommodating a helmet assembly and supports a head by a chassis of a circular shape is arranged. The rotation and the speeds of the subminiature driving electromotor 19, 6 are controlled by an electronic system. A speed of a main worm axis of a motor of the apparatus is reduced via the worm gear. A rotation device and a reciprocal movement device are driven simultaneously and a rotation axis is moved in a reciprocal direction while maintaining a constant angle. An eccentric hole and an eccentric wheel are fixed to a rotation axis, and an eccentric distance can be adjusted.

A steel ball chassis and a rotation pin of a center of a vertical axis line of a helmet are fixed to the edges of the outer helmet. The rotation pin is located at the eccentric hole of the rotation axis and when the rotation axis rotates, the steel ball rotates with centering around the rotation axis via the eccentric wheel. Because of this rotation, the entire outer helmet moves uniformly and the subminiature driving electromotor move to a predetermined position. Further, the rotation pin is connected to a steel ball chassis and a steel ball of a rotation axis and thus the pin allows the entire outer helmet to move in a reciprocal direction consistently.

In addition to the remote controller, a power switch, the subminiature driving electromotor, and a size adjustment of a helmet, two subminiature driving electromotors move in a forward and reverse directions and the speeds of them can be adjusted. At every 3 minutes, they move in a reciprocal direction automatically and a timer and an infrared ray's temperature can be adjusted. The size of a helmet can be adjusted to a maximum by using a position adjustment pressure unit and a music therapy can be applied by reproducing music.

Assembly of the above three kinds: The bottom assembly for a machine installing of a helmet mechanism can be manipulated freely. A case assembly and a chassis assembly of the mechanism are contacted and then inserted each other and a process for mounting a front panel is very simple.

### BRIEF DESCRIPTION OF THE DRAWINGS

FIG. 1 is a front side view of a helmet of a medication head-massaging healthcare and therapy apparatus according to the present invention.

FIG. 2 is a right side view of a helmet of a medication head-massaging healthcare and therapy apparatus according to the present invention.

FIG. 3 is a schematic view showing a connection between the double-layer helmet and a subminiature driving electromotor A.

FIG. 4 is a schematic view showing a structure of a flange on an axis of a subminiature driving electromotor A.

FIG. 5 is a perspective view of the double-layer helmet showing a stainless iron and a spring mounted on a ear of the double-layer helmet.

FIG. 6 is a schematic view of a transmission mechanism comprising worm and worm gear of a subminiature driving electromotor.

FIG. 7 is a schematic view of a massage rod.

FIG. 8, FIG. 9 and FIG. 10 are schematic views of three massage rods of different shapes respectively.

FIG. 11, FIG. 12 and FIG. 13 schematic views of three massage rods of different shapes and different sizes respectively.

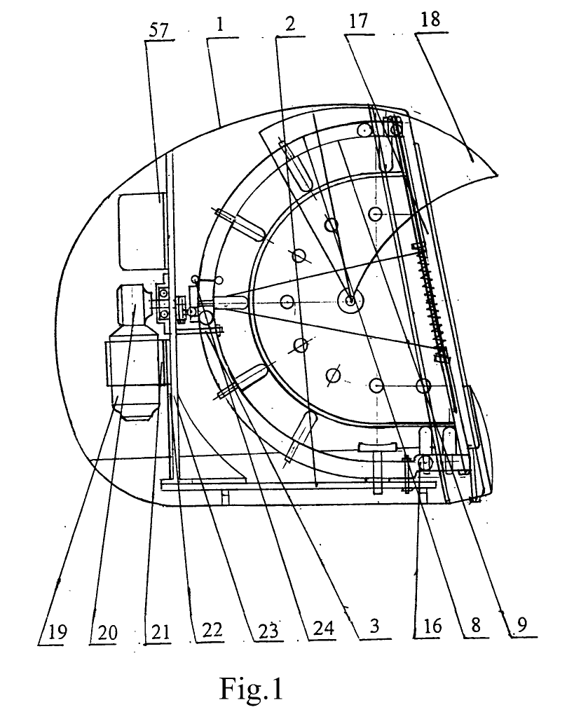

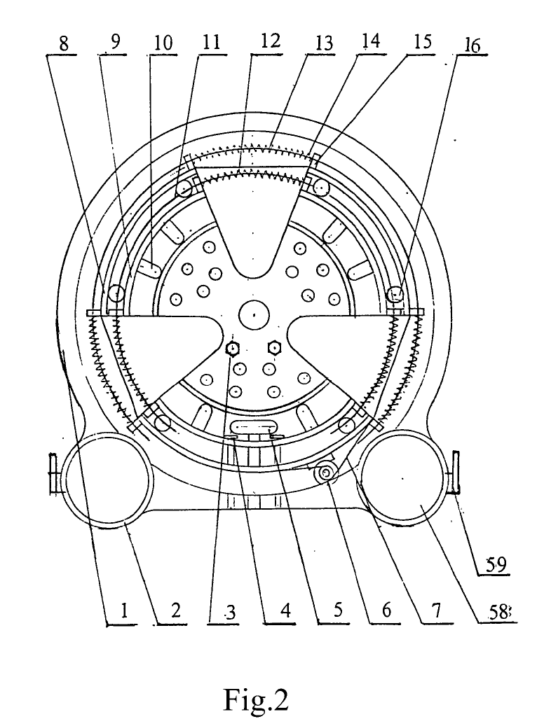

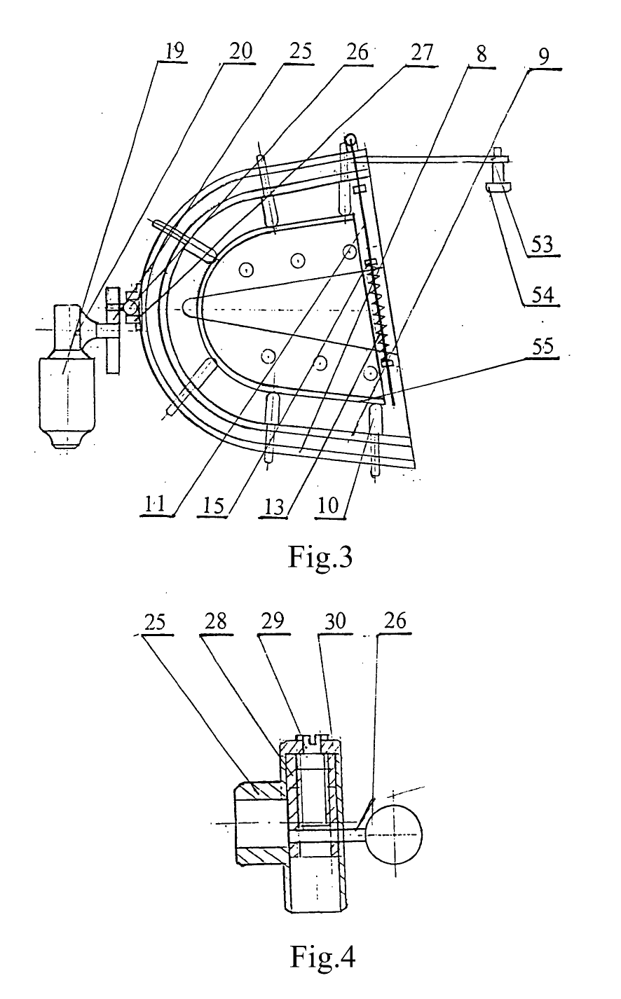

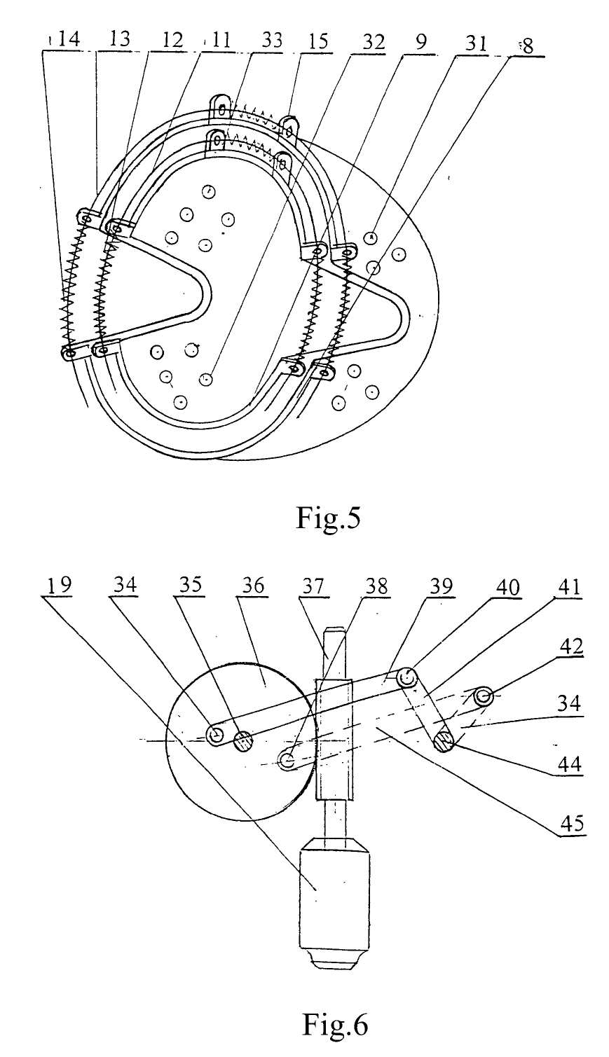

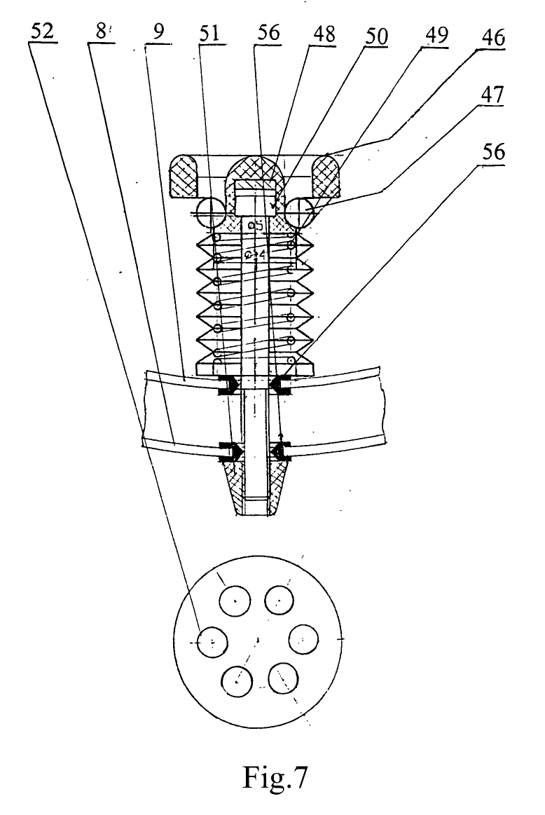

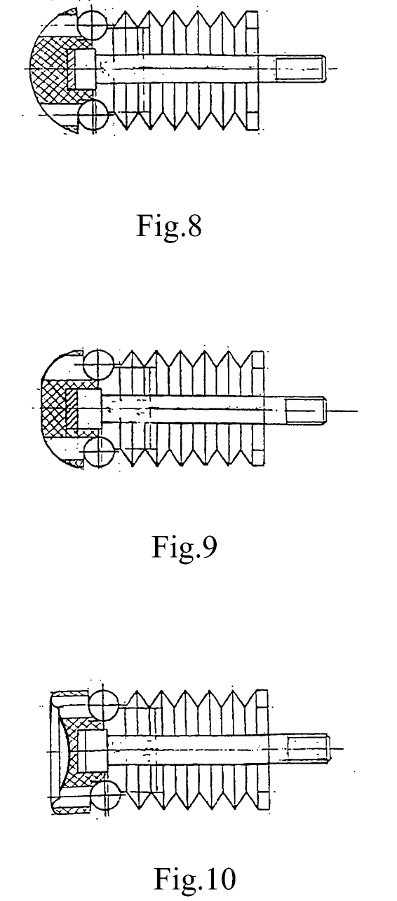

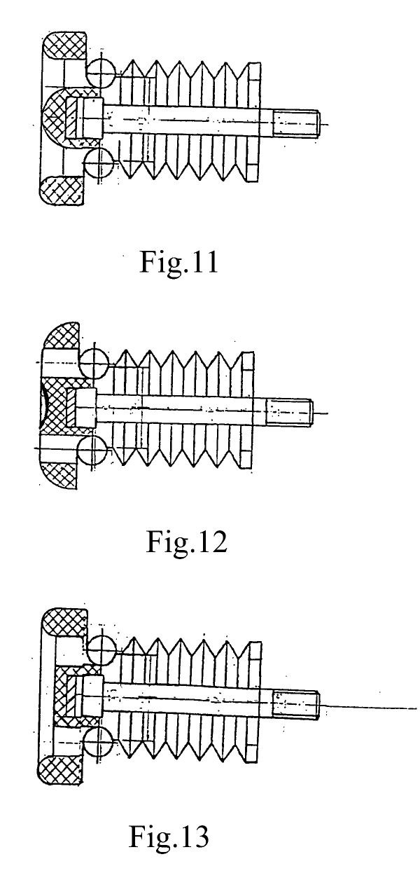

### DETAILED DESCRIPTION OF THE PREFERRED EMBODIMENT

The present invention will be apparent from the following detailed description with the accompanying drawings. A medication head-massaging healthcare and therapy apparatus according to the present invention comprises a case 1, a bottom chassis 2, and a front panel 17. A first subminiature driving electromotor 19 is arranged on the bottom chassis 2. A main axis worm 37 of the first subminiature driving electromotor, a worm gear 38, a speed reduction case 20, and the first subminiature driving electromotor are arranged on a shock absorbing chassis 21, mounted on an upright plate chassis 22 of the bottom chassis 2. The speed reduction case and a speed reduction axis are connected to the top edge of an outer helmet via an upright frame and a sound absorbing upright plate 23. A speed reduction axis of a concave steel ball 27 is fixed to an eccentric flange 25. A nut 28 and a bolt 29 for adjusting an eccentric distance are assembled for fixing a cover 30. A steel ball pin and a steel ball 26 are fixed to the nut 28, and the outer helmet is rotated by assembling the steel ball 26 and a concave steel ball on the outer helmet 8. The outer helmet and a top side of the inner helmet are positioned by a double top ball 24. The edges of the double helmet and a gap friction for supporting a peripheral steel ball 16 are set evenly. Four bolts 3, 4 are fixed to the sound absorbing upright plate and the bottom chassis which are fixed to the inner helmet 9. But, a massage rod 10 arranged on the outer helmet passes through the double-layer helmet and rotates around a core bar 32, 31 of a massage rod arranged in an inner wall and an outer wall of a helmet. The range of movement of the massage rod can be adjusted according to an eccentricity. The portion connected to the edges of an outer layer and an inner layer of the double helmet are divided into three parts and a stainless iron thread or a brass thread 11, 13 are inserted into the holes of the ear 15, 33. The portion is located at six holes and is divided into three parts. A spring 12, 14 arranged among the three parts supports the whole double-layer helmet so as to put a head into a helmet comfortably. A second subminiature driving electromotor 6 is fixed to a bottom side of the outer helmet. The second subminiature driving electromotor is engaged with an axis wire 7 of the subminiature driving electromotor and rotates therewith so that a helmet can be compressed or expanded adequately. During a process of performing a finger-pressure on a head by a massage rod, if a suitable pressure is obtained, a finger-pressure is performed immediately and can be executed freely until patients feel at home. A suitable degree of a finger-pressure operates when the subminiature driving electromotor 19 and a massage is started. At the same time during a massage, the pressure can be adjusted. When performing a massage on a bed, a pillow 5 is arranged on a bottom side of the double-layer helmet so as to allow a shake of the double-layer helmet.

A face protection unit 18 for blocking lights is used for a patient suffering from insomnia or a user who wants sleep.

A music device 58 and a tension unit 59 are arranged on both sides of the case.

A structure of a speed reduction case is illustrated as follows. A worm and a worm gear 36 are rotated by extending a worm 37 of one side of the main axis of the subminiature driving electromotor 19 and a main axis 35 of a worm gear pulls the outer helmet 8 and rotates via a connection unit. A connection rod 39 and a pin 40 are arranged in a reamer pin 34 arranged on one side of an eccentricity of the worm gear so that a crank 41 can be mounted, and a connected swing axis is arranged at a same angle. If the worm gear is rotated until 180°, as illustrated in the drawings, the positions of parts are changed as follows (a connection pin 42, a crank 43, a reamer pin 44 and a connection 45). The swing axis moves in a reciprocal direction at other angle without rotating and a reciprocal movement of the outer helmet on the swing axis is executed according to the movement of the swing axis. Therefore, a reciprocal movement is generated in a massage rod of an inner layer of the double-layer helmet.

A structure of a massage rod is illustrated as follows. The edges of a massage rod have different shapes and the massage rod comprises a top edge 46, an infrared rays unit 47, a magnet 48, a pressure spring 49, a core bar 50, a nut 51, and an infrared rays hole 52 according to demand of patients.

A structure of a long rod is illustrated as follows. A long rod 53 is arranged in an outer helmet. Thus, a massage rod 54 performs a massage on a forehead and a face.

A medication cap is illustrated as follows. A disposable medication cap 55 injects a medication including different components into a medication cap according to a cerebral illness based on sanitation and therapy demand of a patient.

What is claimed is:

1. A medication head-massaging healthcare and therapy apparatus, comprising:
a case, a bottom chassis for mounting a helmet, a front panel, a double-layer helmet, a plurality of massage rods, and a subminiature driving electromotor, wherein the double-layer helmet is divided into a top side, a left side and a right side, and is connected to a motor that is adjusted to a size of an open circumference, and can control a infrared rays unit arranged in a neck area of the massage rod by using a remote controller or a wired remote controller of the apparatus; a magnet is arranged on a neck area of the massage rod; a disposable medication cap is used; a head portion is supported by a support plate that is vertically extended to a center of a bottom side in the bottom chassis for a helmet mounting in the bottom side of the case; operations of the subminiature driving electromotor are controlled by an electronic system; a main axis worm of a motor and a worm gear of the subminiature driving electromotor are connected each other; a rotation axis of a worm gear for a speed reduction, and a swing structure rotate at the same time; a steel ball on a swing axis that rotates in a reciprocal direction while maintaining a constant angle against the rotation axis of the worm gear is connected to a steel ball support chassis at an edge of an outer helmet; a flange is fixed to the rotation axis of a worm gear; a small bolt axis, one steel ball, and a support chassis for the steel ball and the outer helmet steel ball are fixed to an eccentric hole; in case of massaging healthcare and therapy, the subminiature driving electromotor enables the helmet to rotate or oscillate;
wherein the helmet has a double structure; an inner helmet is fixed to a bottom chassis and a sound absorbing chassis; a concave hole of a round shape is formed at the periphery of the outer helmet; a flange is arranged on a worm gear axis of the subminiature driving electromotor 19; a steel ball that is formed integrally with an eccentric axis pin and a concave hole are positioned at an edge of the outer helmet on one side of the flange, thereby making the helmet rotate or move consistently according to rotation of the subminiature driving electromotor;
wherein if the flange is moved and mounted on other position of the subminiature driving electromotor, when a locker arm moves along an rotation axis, the outer helmet is moved in a reciprocal direction due to the movement; the massage rod is arranged on a hole of the double helmet so that a starting position thereof can be oriented toward an inner layer; the starting position of the massage rod corresponds to an acupuncture point; the massage rod can include a soft massage; a portion folded as a cylindrical shape of the massage rod is fixed by adjusting a pressure spring, a core bar and a nut; massage rods of different types can be arranged selectively at edges of the massage of based on a head disease health and therapy; and the infrared rays unit arranged in the neck area of the massage rod can adjust temperature through a stable circuit so that a drug ion can be injected.

2. The medication head-massaging healthcare and therapy apparatus set forth in the claim 1, wherein the double-layer helmet is divided into three portions which are connected each other; a pair of ear flaps are formed in each groove, holes of the ear flaps are connected by winding wires; a spring of the double helmet can be supported entirely due to space of the groove since the pressure spring is arranged on the wires; forward rotation of the subminiature driving electromotor 6 expands or reduces all portions of the double helmet; a volume size of an inner side of the helmet can be adjusted by expansion or reduction of the helmet; maximum limit of expansion or reduction of the double-layer helmets controlled by a position limiter; six steel ball rods the positions of which are not changed are designated as steel balls at an outer periphery of a helmet steel ball of the inner helmet; the outer helmet and the inner helmet make frictions; the edges of the double-layer helmet are fixed by a steel ball and in particular, are fixed by two position fixing steel balls which can adjust a distance; tension of hinges of the inner helmet and the outer helmet fixes the helmet to the inner layer; and rotation or reciprocal movement of the outer helmet can not be hindered.

3. The medication head-massaging healthcare and therapy apparatus set forth in the claim 1, wherein a helmet mounting chassis is fixed by a bolt on a center portion of the inner helmet; a uniform gap is formed among steel balls since steel balls are arranged on periphery of the inner helmet and the outer helmet; an insertion massage rod of the double-layer helmet penetrates through a fixed inner helmet and a corresponding hole and is arranged inside all helmets; each massage rod is arranged in a wall of the inner helmet; a mounting unit of a card is fixed in a corresponding hole; when the outer helmet executes a locking turn, the insertion massage rod rotates according to a hole arranged by the card; and the massage rod contacts with an acupuncture point for executing massage.

4. The medication head-massaging healthcare and therapy apparatus set forth in the claim 3, wherein massage rods having a spherical shape of a semicircle, a cylindrical body of a semi-spherical shape, a conic body of a semi-spherical shape, or a concave type of circumferential shape of different sizes may be arranged at the edges of the helmet, and a massage rod of a concave type is arranged at a center of a front tip.

5. The medication head-massaging healthcare and therapy apparatus set forth in the claim 1, wherein the helmet is fixed and then arranged by a long rod and a tip of the long rod can be contacted with a forehead and a front face, respectively.

6. The medication head-massaging healthcare and therapy apparatus set forth in the claim 5, wherein in case of massage of the front face and the forehead, a diameter of a conic body arranged at a periphery of the massage rod is 30-40 mm.

7. The medication head-massaging healthcare and therapy apparatus set forth in the claim 6, wherein a magnet is mounted inside the periphery of the massage rod.

8. The medication head-massaging healthcare and therapy apparatus set forth in the claim 7, wherein the infrared rays unit arranged in the neck area of the massage rod can adjust temperature, and medication can deposit into acupuncture point of a head.

9. The medication head-massaging healthcare and therapy apparatus set forth in the claim 8, wherein the disposable medication cap can mix different medication materials.
